(19) United States
(12) Patent Application Publication
(10) Pub. No.: US 2007/0016425 A1
(43) Pub. Date: Jan. 18, 2007

(54) Device for providing perception of the physical environment

(76) Inventor: Koren Ward, New South Wales (AU)

Correspondence Address: WELSH & KATZ, LTD, 120 S RIVERSIDE PLAZA, 22ND FLOOR, CHICAGO, IL, 60606, US

(21) Appl. No.: 11/179,261

(22) Filed: Jul. 12, 2005

(51) Int. Cl. G10L 21/06; H01H 15/00

(52) U.S. Cl. 704/271; 200/16 D; 715/729

(57) ABSTRACT

A sensory substitution device for enabling a user to perceive 3D structure, and optionally colour, of the environment. Image and range data derived from the sensor assembly is mapped into a low resolution 2D array such that each element of the 2D array contains the distance of the sampled region from the sensor assembly, and optionally the predominate colour of the corresponding sampled region. To interpret the range, and optionally colour data, elements of the 2D array are converted to electrical signals with frequency and intensity determined by the colour and range of the associated array element respectively. Each signal is used to stimulate nerves in the skin via electro-tactile electrodes or vibro-tactile actuators. The tactile electrodes (or actuators) are arranged in a manner that enables the user to intuitively determine from which array element and corresponding image component the signal has originated. Different frequencies represent different colours.

### TECHNICAL FIELD

The present invention generally relates to devices that assist a vision impaired person perceive the surrounding physical environment, and more particularly to a device for providing perception of the physical or spatial environment about a user which utilises depth information mapped to a tactile interface attached to or operatively associated with a user, for example a blind user.

### BACKGROUND ART

It is difficult to imagine something more profoundly disabling than losing the sense of sight. Yet blindness occurs to many thousands of people every year as a result of injury, disease or birth defects. Bionic vision in the form of artificial silicon retinas or external cameras that stimulate the retina, optic nerve or visual cortex via tiny implanted electrodes are currently under development (see: Wyatt, J. L. and Rizzo, J. F., Ocular Implants for the Blind, IEEE Spectrum, Vol. 33, pp. 47-53, May 1996; Rizzo, J. F. and Wyatt, J. L., Prospects for a Visual Prosthesis, Neuroscientist, Vol. 3, pp. 251-262, July 1997; and Rizzo, J. F. and Wyatt, J. L., Retinal Prosthesis, in: Age-Related Macular Degeneration, J. W. Berger, S. L. Fine and M. G. Maguire, eds., Mosby, St. Louis, pp. 413-432,1998).

Currently, the only commercially available artificial vision implant is the Dobelle Implant (Dobelle, W. Artificial Vision for the Blind by Connecting a Television Camera to the Visual Cortex, American Society of Artificial Internal Organs Journal, January/February 2000). This is comprised of an external video camera connected to a visual cortex implant via a cable. Once implanted, this provides the user with visual perception in the form of a number of perceivable “phosphenes”. Unfortunately, this form of perception bears no resemblance to the environment and has only been demonstrated to be useful for simple classification tasks like learning to classify a small set of large alphabetic characters.

Even if more successful results are achieved with implants in the not so distant future, many blind people may not benefit from implants due to the high cost and the expertise required to surgically implant such a device. Some forms of blindness (eg. brain or optic nerve damage) may also be unsuitable for implants.

Various audio vision substitution sensory aids have been developed. These work by encoding a coarse camera image or sensor data into a sequence of sounds that can be interpreted by the user. One such device, developed by Meijer (Meijer, P.B.L. An Experimental System for Auditory Image Representations, IEEE Transactions on Biomedical Engineering, Vol. 39, No. 2, pp. 112-121, February 1992. Reprinted in the 1993 IMIA Yearbook of Medical Informatics, pp. 291-300) and named the vOICe, attempts to provide the user with visual cognition by encoding camera image data into sounds. This is done by compressing the camera image into a coarse 2D array of grayscale values and by then converting each grayscale element into a sound with a specific frequency. This audio information is then delivered to the ears via headphones by sequentially scanning the 2D array of sounds row by row until the entire “soundscape” is heard.

Consequently, the time needed to listen to an entire frame of image data results in a very slow frame rate and it is difficult for the user to reconstruct the image mentally from the tones. It appears, there simply is too much information comprising video frames for any significant auditory interpretation to be possible by this means in real-time. Even if it were possible for a user to mentally reconstruct an image's original greyscale grid by carefully listening to the image's “soundscape”, this grid would be either too coarse to reveal any environmental details, or would take too long to listen to for real-time cognitive image processing to be possible. Furthermore, by being a course 2D greyscale representation of a 3D environment, it may also be impossible for the user to perceive the location of objects in 3D space which is necessary for obstacle avoidance and navigation. Consequently, little benefit is able to be demonstrated by users wearing this device apart from doing some simple tasks like identifying the direction of an isolated linear object or finding a significant object lying on a uniformly coloured floor.

Other audio vision substitution sensory aids encode the distance and/or texture of sensed surfaces with sounds. The most significant work in this area has been Lesley Kay sonar mobility aids for the blind. (Kay, L. Auditory Perception of Objects by Blind Persons Using Bioacoustic High Resolution Air Sonar. JASA, Vol 107, pp 3266-3275, No 6, June 2000). Kay's work is significant because his Binaural, Trisensor and Sonic Torch sonar systems utilise frequency modulated signals, which represent an object's distance by the pitch of the generated sound and the object's surface texture by the timbre of the sound delivered to the headphones. However, to an inexperienced user, these combined sounds can be confusing and difficult to interpret. Also, the sonar beam from these systems is very specular in that it can be reflected off many surfaces or absorbed resulting in uncertain perception. Also, only a small part of the environment can be sensed at any instant and learning to interpret all possible sounds can be difficult.

A further drawback of auditory substitute vision systems is that by using the ears as the information receptor, they can interfering with a blind person's normal auditory cognitive abilities. This is particularly undesirable as the sense of hearing is important to the blind for their awareness of what is occurring in their immediate vicinity. Consequently, these devices are not widely used in public places because they can actually reduce a blind person's perception of the environment and could potentially cause harm or injury by reducing a blind person's capacity to detect impending danger from sounds or noise, (eg. moving cars, people calling out, alarms, a dog barking, etc.).

Electro-tactile displays for interpreting the shape of images on a computer screen with the fingers, tongue or abdomen have been developed by Kaczmarek et al (Kaczmarek, K. A. and Bach-y-Rita, P., Tactile Displays, in Virtual Environmants and Advanced Interface Design, Barfield, W. and Furness, T., Eds. New York: Oxfork University Press, pp. 349-414, 1995). These displays work by simply mapping black and white pixels to a matrix of closely spaced pulsated electrodes which can be felt by the fingers. Although these electro-tactile displays can give a blind user the capacity to recognise the shape of certain objects, like black alphabetic characters on a white background, they do not provide the user with any useful 3D perception of the environment which is needed for environment navigation, localization, landmark recognition and obstacle avoidance.

Although electro-tactile and vibro-tactile displays have been demonstrated to be useful for interpreting text characters against plane contrasting backgrounds, the image resolution capability of skin in contact with these devices is too low for the user to be able to perceive indoor or outdoor environments in a meaningful or useful way. Consequently, existing blind aids including electro-tactile and vibro-tactile devices are unable to provide the blind with the ability to perform localisation, navigation or obstacle avoidance within typical indoor and outdoor environments.

This identifies a need for a device for providing perception of the physical or spatial environment about a user which addresses or at least ameliorates problems inherent in the prior art.

The reference to any prior art in this specification is not, and should not be taken as, an acknowledgment or any form of suggestion that such prior art forms part of the common general knowledge.

### DISCLOSURE OF INVENTION

According to a first broad form, the present invention provides a device for providing perception of the spatial environment about a user, the device comprising: at least one range sensing device; a processing device to receive data from the at least one range sensing device and to generate a depth map from at least some of the data; a signal converter to generate an electrical signal corresponding to an area of the depth map; and, a tactile interface to receive the electrical signal, the tactile interface operatively attached to the user.

Preferably, the device is a sensory aid for a blind user. Also preferably, the signal converter generates a plurality of electrical signals each corresponding to one of a plurality of areas of the depth map.

In other particular, but non-limiting, forms: the at least one range sensing device includes a camera and a range sensor; the range sensor may be a scanning range sensor; the at least one range sensing device may be a stereo camera set comprising a first camera and a second camera; and/or the at least one range sensing device may comprise a plurality of range sensors.

In still a further particular, but non-limiting, form the tactile interface includes one or more electrodes and/or the tactile interface includes one or more transducers.

In accordance with specific optional embodiments, provided by way of example only: the one or more transducers are vibro-tactile actuators; the tactile interface includes one or more electrodes and one or more transducers; the tactile interface is adapted to be at least partially attached to the abdomen of the user; the tactile interface is arranged as a two-dimensional array on a region of skin of the user; and/or, the tactile interface is in the form of one or two gloves and comprises up to ten electrodes and/or transducers each corresponding to a digit of the user's hands.

Optionally, but not necessarily, the at least one range sensing device may be adapted to be mounted on the user's head.

In still a further particular, but non-limiting, forms: the processing device also generates a colour map corresponding to the depth map; and/or, the signal converter also modulates the electrical signal corresponding to a predominant colour of an area of the colour map and the depth map.

Optionally, but not necessarily, the tactile interface comprises a two-dimensional array of vibro-tactile actuators and different frequencies of operation of the vibro-tactile actuators correspond to different colours.

According to a second broad form, the present invention provides a method of providing perception to a user of the spatial environment about the user, the method including the steps of: using at least one range sensing device provided on or about the user to receive electromagnetic radiation from the spatial environment about the user; processing in a processing device data received from the at least one range sensing device and generating a depth map from at least some of the data; generating in a signal converter an electrical signal corresponding to an area of the depth map; and, receiving in a tactile interface the electrical signal, the tactile interface operatively attached to the user.

According to a third broad form, the present invention provides a sensory aid comprising: range and vision sensor devices for obtaining an array of colour and range readings from the environment; processing hardware connected to the range and vision sensor devices; and, a configuration of electro-tactile electrodes or vibro-tactile actuators mounted on the skin of a user; wherein, the array of colour and range readings are mapped to the configuration of electro-tactile electrodes or vibro-tactile actuators, such that the direction and distance of objects in the environment can be sensed by the location and the intensity of the stimulation from the electro-tactile electrodes or vibro-tactile actuators, also such that the colour of objects in the environment can be sensed by the frequency of the stimulation.

### BRIEF DESCRIPTION OF FIGURES

An example embodiment of the present invention will become apparent from the following description, which is given by way of example only, of a preferred but non-limiting embodiment, described in connection with the accompanying figures.

FIG. 1 illustrates an example embodiment showing the main components of a 3D perception device;

FIG. 2 illustrates a specific example embodiment of the device illustrated in FIG. 1;

FIG. 3 illustrates an alternate specific example embodiment of the device illustrated in FIG. 1;

FIG. 4 illustrates an example form of a tactile interface;

FIG. 5 illustrates an alternate example form of a tactile interface;

FIG. 6 illustrates a more detailed specific example of the device illustrated in FIG. 3;

FIG. 7 illustrates an example interface for monitoring the performance of the device; and,

FIG. 8 illustrates an example interface for monitoring the performance of the device in a different environment to that illustrated in FIG. 7.

### MODES FOR CARRYING OUT THE INVENTION

The following modes, given by way of example only, are described in order to provide a more precise understanding of the subject matter of a preferred embodiment or embodiments. In the figures, incorporated to illustrate features of example embodiments, like reference numerals are used to identify like parts throughout the figures.

### Preferred Embodiment

A preferred embodiment provides a 3D substitute vision device which enables a user, for example, though not necessarily, a blind user, to perceive the 3D structure, and optionally colour, of the immediate environment in sufficient detail for localisation, navigation and obstacle avoidance to be performed. The user interface utilises redundant nerves in the skin that provide an intuitive interface for the 3D structure of the environment to be perceived via artificial sensors. Various embodiments are described that provide a user with colour information, however it should be appreciated that provision of colour information is optional and not essential to the invention.

A particular example embodiment is described as a sensory aid for enabling the blind to perceive the location and colour of objects, features and surfaces in the surrounding environment via electro-tactile electrodes and/or vibro-tactile actuators. The sensory aid includes image and range sensors, preferably worn by the user on the head or elsewhere, that regularly capture image and range information from the environment within the image sensor's field of view. During each capture period, the image and range data is processed into a 2D array of preset size (n×m), which may be a 1D array (1×m), covering the field of view such that each element of the 2D array optionally contains the predominate colour of the corresponding sampled region of the environment and preferably contains the distance of the sampled environment region from the sensor assembly.

To interpret the image and range data, the colour and range of selected elements of the 2D sensory array are converted to electrical signals with frequency and intensity determined by the colour and range of the respective array elements. These signals are used to stimulate nerves in the skin of the user via electro-tactile electrodes and/or vibro-tactile actuators placed on the skin at specific locations. The tactile electrodes and/or actuators are arranged in a manner that enables the user to intuitively determine the array element from where the sensory signals originate and subsequently the corresponding component of the visual field of the sensor assembly used to sense the environment.

For example, the user might choose to place a number of electrodes (and/or actuators) on the abdomen (or on other parts of the body) in a matrix configuration that corresponds to the sensory 2D array. By intuitively mapping nerves to sensory array elements in this manner the user can instantly determine the distance and location of objects (or any detectable surface) in the environment. Furthermore, the colour of detected surfaces can also be recognised by the frequency of the stimulation, providing the detected colour has previously been mapped to a specific frequency. Identification of familiar colours in this way is particularly useful for recognising familiar landmarks and maintaining localisation.

The main advantage of the 3D substitute vision device/system comes from the continuous intuitive delivery of environmental range and, optionally, colour information to the user and the capacity of the human brain to maintain temporal spatial awareness of the surrounding environment from limited sensory information. By being able to continuously perceive and update the relative location of surrounding objects and surfaces, in addition to recognising landmarks by their colour, the user is able to maintain a cognitive 3D map of the immediate environment and is able to competently navigate the environment from this spatial awareness.

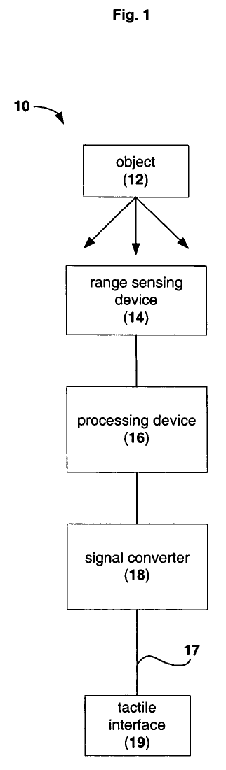

FIG. 1 illustrates a device 10 for providing perception of the spatial environment about a user. Although other uses are possible the device is intended for a blind user. The device 10 is intended to allow the user to perceive object 12 in the physical environment about the user. Device 10 includes range sensing device 14 which senses one or more objects 12 in the environment about the user. Range sensing device 14 can be a variety of sensing devices able to sense the range, i.e. the distance, from the range sensing device 14 to object 12.

Range sensing device 14 is connected to processing device 16 which receives data from range sensing device 14 and generates a depth map from at least some of the data from range sensing device 14. If appropriate, all data from range sensing device 14 could be processed by processing device 16. As an example, processing device 16 could be dedicated processing hardware or a portable computing device. Processing device 16 outputs data to a signal converter 18 which receives data corresponding to the depth map and generates at least one electrical signal 17 corresponding to at least one area of the depth map. Signal converter 18 could be incorporated into processing device 16 as a single unit or device.

Preferably, signal converter 18 generates a plurality of electrical signals corresponding to each of a predefined area of the depth map. Signal converter 18 is connected to tactile interface 19 which receives the one or more electrical signals 17 from signal converter 18. Tactile interface 19 is operatively attached to the user, preferably, but not necessarily, being attached to the skin of the user.

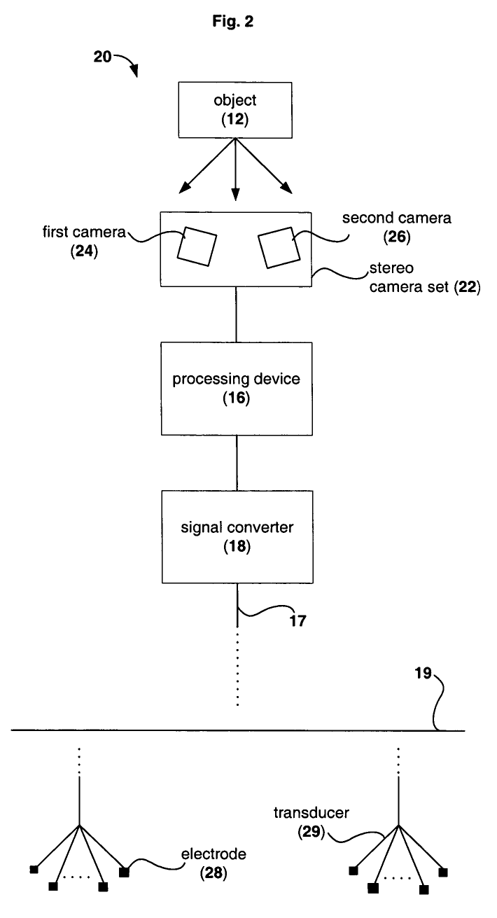

Referring to FIG. 2 there is illustrated a further particular example embodiment. Device 20, for providing perception of the spatial environment about a user, embodies range sensing device 14 as a stereo camera set 22. Stereo camera set 22 includes a first camera 24 and a second camera 26. Operation of first camera 24 and second camera 26 allows two visual images to be obtained and compared, thereby enabling the depth of object 12 within the visual images to be calculated. Calculations of the depth or range of object 12 occur in processing device 16. Also shown in FIG. 2 are forms of tactile interface 19. Tactile interface 19 may include one or more electrodes 28 and/or one or more transducers 29, either separately or in various combinations. Electrodes 28 and transducers 29 are illustrated as being of indefinite number, with the exact number variable and determined by a particular application, eg. applied to the fingers or other parts of the body.

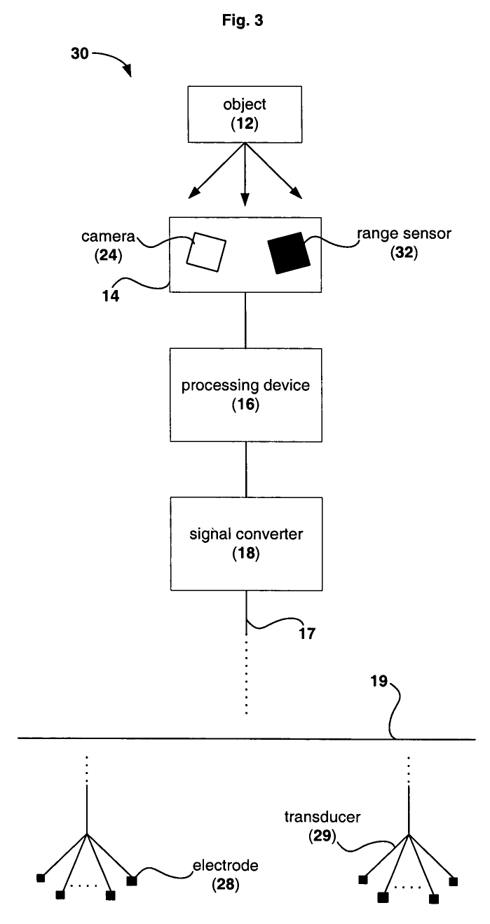

Referring to FIG. 3, there is illustrated a further alternate embodiment. Device 30 is similar to device 20 except that range sensing device 14 is not a stereo camera set 22 but includes a single camera 24 and a range sensor 32. More than one camera 24 and/or more than one range sensor 32 can be provided if desired. In this embodiment, processing device 16 does not need to calculate the depth of object 12 by comparison of images from separate cameras as range sensor 32 can directly provide depth information. Range sensor 32 may be a scanning range sensor or a plurality of standard or scanning range sensors. Preferably, though not necessarily, camera 24 is a colour video camera.

Signal converter 18 can generate a plurality of electrical signals 17 each corresponding to a plurality of areas of a depth map. Furthermore, electrical characteristics of electrical signal 17 can be altered using signal converter 18. For example, the amplitude or frequency of electrical signal 17 could be altered or modified by electrical signal converter 18 in response to some environmental factor, for example, the colour of object 12. Other possibilities for modification of electrical signal 17 are possible. For example, electrical signal 17 could modified to be a series of dots/dashes (cf. morse code) ot impart additional information to the user. These types of signals could also be used to impart information about a landmark, object or text which is recognised after additional processing by processing device 16.

Other options are also possible, for example modulating signal 17 in certain ways might represent the texture of a surface as sampled by an additional sensor in range sensing device 14. As a further example, the temperature of object 12 might be sensed by an infrared (IR) sensor incorporated in range sensing device 14, which could also be the range sensor(s) 32. The temperature could be relayed to the user via modulation of electrical signal 17, eg. by a higher frequency than is typically used for colour information. This may assist a user in locating, or alerting the user to the presence of, potentially dangerous objects such as stove tops, heaters, hot water, etc..

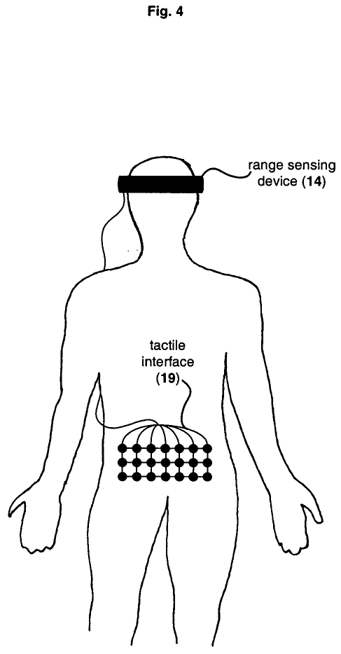

Referring to FIG. 4, tactile interface 19, being an array of electrodes 28 and/or transducers 29, can be attached to the abdomen of the user. Tactile interface 19 may be wholly attached to the skin of the abdomen of the user, or only some electrodes 28 or transducers 29 may be attached to the abdomen region with other electrodes 28 and/or transducers 29 attached to other parts of the user, for example the user's limbs.

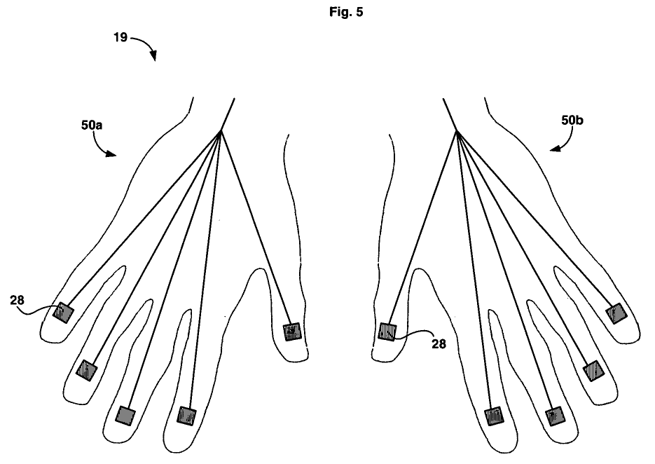

Referring to FIG. 5, in another particular embodiment tactile interface 19 may be in the form of two gloves 50a, 50b, to be placed on or over the hands of a user. Each glove 50a, 50b includes electrodes 28 (or vibrators, i.e. actuators) that contact the skin of a digit of the user's hand to thereby impart an electrical pulse or vibration to the skin of the user.

Preferably, although not necessarily, range sensing device 14 is adapted to be mounted on the user's head. However, range sensing device 14 may be located at numerous other positions about the body of the user.

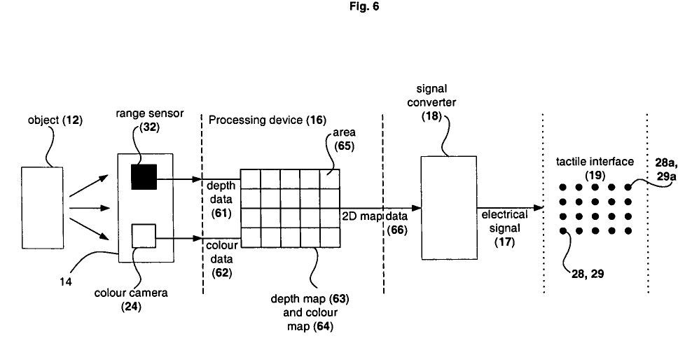

Referring to FIG. 6, a further particular embodiment is illustrated. Range sensing device 14, including colour camera 24 and range sensor 32, detects electromagnetic radiation reflected from object 12. Range sensing device 14 provides depth data 61 and colour camera 24 provides colour data 62 to processing device 16. Processing device 16 uses depth data 61 and colour data 62 to generate a depth map 63 and a colour map 64 which are illustrated as being overlaid so that a particular area 65 of depth map 63 corresponds to the same area 65 of colour map 64. Processing device 16 provides the 2D map data 66 to signal converter 18. Signal converter 18 can then use the 2D map data 66 to produce an electrical signal 17 having depth and colour information.

Electrical signal(s) 17 is passed to tactile interface 19 which comprises an array of individual electrodes 28 and/or transducers 29. The array of electrodes 28/transducers 29 may correspond to areas of the depth map 63 and colour map 64. Tactile interface 19 may be attached to various positions on the skin of a user, for example, on the user's abdomen. A particular electrode 28a or transducer 29a may therefore directly correspond with area 65. The amplitude or intensity of electrical signal 17 can be used to represent the depth of an object sampled in an area of the depth map whilst the frequency of electrical signal 17 can be used to represent the colour of the object sampled in the area of the depth map. Hence, operation of tactile interface 19 can vary according to the modulated electrical signal 17.

In a preferred embodiment, device 10 is a sensory aid for the blind and range sensing device 14 includes range and vision sensor devices for obtaining an array of colour and range readings from the environment about the sensing aid which is worn by the user. Also preferably, tactile interface 19 is a configuration of electro-tactile electrodes or vibro-tactile actuators mounted on the skin of the user. The array of colour and range readings from the range and vision sensor devices are mapped to the configuration of electro-tactile electrodes or vibro-tactile actuators, such that the direction and distance of objects in the environment can be sensed by the location and the intensity of the stimulation from the electro-tactile electrodes or vibro-tactile actuators, and also such that the colour of objects in the environment can be sensed by the frequency of the stimulation.

Numerous other embodiments of the invention are possible. For example, range sensing device 14 could be a device or devices other than a camera, set of cameras and/or IR range sensor(s). Range sensing device 14 could utilise one or more fixed or scanning lasers, sonar, or any other type of device in which a signal can be used to obtain a distance measurement, for example by measuring a phase change or time delay of a reflected signal.

In a further example, GPS could also be utilised as a means of determining the location of some objects, for example landmarks, if such objects have a known or measurable absolute position. Range sensing device 14 can include a GPS transmitter/receiver so that the absolute position of range sensing device 14 can be determined. Object and range sensing device 14 position information can be provided as input to range sensing device 14 (or directly to processing device 16), which in this example is adapted to receive a GPS signal. Processing device 16 could then perform coordinate transformations to calculate the range of objects, for example a building, relative to the range sensing device 14 (i.e. the user).

In still a further example embodiment, when at least one camera is utilised it is possible to provide a large amount of additional information to the user. Processing of visual images by processing device 16 can be extended to applications such as object identification, identification of persons (for example by facial recognition), identification and location of edges (for example holes or gaps), identification of indicia (for example identification of text in signs, advertising, street names, hazard warnings, etc., by optical character recognition), identification of surface textures, temperatures, etc.. This additional information could be provided to the user via tactile interface, for example by modulation of electrical signal 17, or could be provided to the user in other forms. For example, an audio speaker might relay words or numbers to the user after optical character recognition has been performed.

### FURTHER EXAMPLES

The following examples provide a more detailed discussion of particular embodiments. The examples are intended to be merely illustrative and not limiting to the scope of the present invention.

In a particular alternate but non-limiting example, the device provides depth information from a stereo camera set as illustrated in FIG. 2, and may also optionally provide colour information. The device may be viewed as providing a vision system which works by extracting depth information from stereo cameras and delivering this information to the user via ten electro-tactile electrodes or vibro-tactile actuators placed horizontally across the front of the abdomen. To interpret the range data, the user only has to imagine that lines are projected from the electrodes or actuators at normal to the surface of the skin. The amount of stimulation felt at each electrode or actuator indicates the distance to objects in the direction of the projected lines.

By having environmental depth information delivered continuously to the user in a form that is easy to interpret, the user is able to realise the 3D profile of the environment and the location of objects in the environment by surveying the environment with the cameras. This form of 3D environment perception can then be used to navigate the environment, recognise the user's location in the environment and perceive the size and movement of objects within the environment without using the eyes.

This particular example embodiment is hereinafter referred to as an Electro-Neural Vision System (ENVS). The ENVS includes a stereo video camera headset for obtaining video information from the environment, a computer or other processing device for processing the video data, a Transcutaneous Electro-Neural Stimulation (TENS) unit for converting the output from the computer into appropriate electrical pulses that can be felt via the skin, and a linear array of TENS electrodes for delivering the electrical pulses to the skin.

The ENVS works by using the computer to obtain a disparity depth map of the immediate environment from the head mounted stereo cameras. This is then converted into electrical pulses by the TENS unit that stimulates nerves in the skin via the TENS electrode array. To achieve electrical conductivity between the electrodes and skin, a small amount of conductive gel may be applied to the electrodes prior to placing the electrodes on the skin.

An important factor in obtaining useful environmental information from the TENS electrodes lies in representing the range data delivered to the user in an intuitive manner. To interpret this information the user simply imagines lines extended normal to the electrodes. The amount of stimulation felt at each electrode is proportional to the distance of objects in the direction of the extended lines. A typical TENS pulse frequency may be 20 Hz and the amplitude to between 40V to 80V, depending on individual user comfort. To control the intensity felt by each finger the ENVS adjusts the pulse width between, for example, 10 to 100 μs.

The applicant has found adjusting the signal intensity by varying the pulse width preferable to varying the pulse amplitude for two reasons: (1) it enabled the overall intensity of the electro-neural simulation to be easily set to a comfortable level by presetting the pulse amplitude; and (2) it also simplified the TENS hardware considerably by not needing any digital to analogue converters or analogue output drivers on the output circuits.

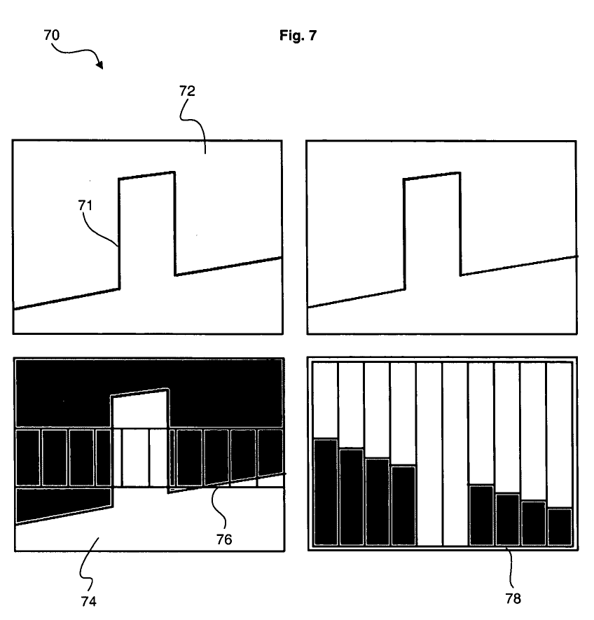

For testing or other purposes the ENVS may be provided with a control panel which can also be designed to monitor the image data coming from the cameras and the signals being delivered to the electrodes via the TENS unit. Referring to FIG. 7, there is illustrated a simplified example of a screen grab 70 of the ENVS's control panel while in operation. The top-left image 72 shows a simplified environment image including feature or object 71 (in this example a door) obtained from one of the cameras in the stereo camera set. The corresponding disparity depth map, derived from both cameras, can be seen in the bottom-left image 74. Also, ten disparity depth map sample regions 76, used to obtain the ten range readings delivered to the electrodes, can be seen spread horizontally across the centre of the disparity map image 74. These regions are also adjustable via the control panel. It should also be appreciated that any number of disparity map sample regions could be utilised and the size or location of a disparity map sample region could be varied.

To calculate the amount of stimulation delivered to the skin by an electrode or actuator, the minimum depth of each of the ten sample regions 76 is taken. The bar graph 78, at the bottom-right of FIG. 7, shows the actual amount of stimulation delivered to a region of the skin. Using a 450 MHz Pentium 3 computer the applicant was able to achieve a frame rate of 15 frames per second which proved more than adequate.

The ENVS works by using the principle of stereo disparity. Just as a person's eyes capture two slightly different images and the person's brain combines them with a sense of depth, the stereo cameras in the ENVS captures two images and the computer computes a depth map by estimating the disparity between the two images. However, unlike binocular vision on humans and animals, which have independently moveable eye balls, the stereo vision system uses parallel mounted video cameras positioned at a set distance from each other. In the applicant's trials, a pair of parallel mounted DCAM video cameras manufactured by Videre Design were used. The stereo DCAMs interface with the computer via a firewire port.

The process of calculating a depth map from a pair of images using parallel mounted stereo cameras is known (see Banks, J. Bennamoun, M. and Corke, P., Non-Parametric Techniques for Fast and Robust Stereo Matching. In IEEE TENCON'97, Brisbane, Australia, December 1997). By knowing the baseline distance between the two cameras and their focal lengths the coordinates of corresponding pixels in the two images can be used to derive the distance to the object from the cameras at that point in the images.

Calculating the disparity between two images involves finding corresponding features in both images and measuring their displacement on the projected image planes. If the horizontal offsets of the pixel in question from the centre of the image planes are represented by xl and xr for the left and right images respectively and the focal length is f with the baseline b, then by using the properties of the similar triangles z=f(b/d), where z is the distance to the subject and d is the disparity (xl-xr). To compute a complete depth map of the observed image in real time is computationally expensive because the detection of corresponding features and calculating their disparity has to be done at frame rate for every pixel on each frame.

The stereo disparity algorithm requires automated detection of corresponding pixels in the two images, using feature recognition techniques, in order to calculate the disparity between the pixels. Consequently, featureless surfaces can pose a problem for the disparity algorithm due to a lack of identifiable features. To make an ENVS user aware of this, the ENVS can maintain a slight signal if a region contains only distant features and no signal at all if the disparity cannot be calculated due to a lack of features in a region. Alternatively or additionally, to overcome this deficiency an IR range sensor(s) can be incorporated into the ENVS, for example placed near the cameras. Also, as explained previously, a single camera might be used with an IR range sensor(s) as the depth map, which in this case is not a disparity depth map, could be calculated directly from the IR range sensor(s) data with requiring depth calculations from two camera images.

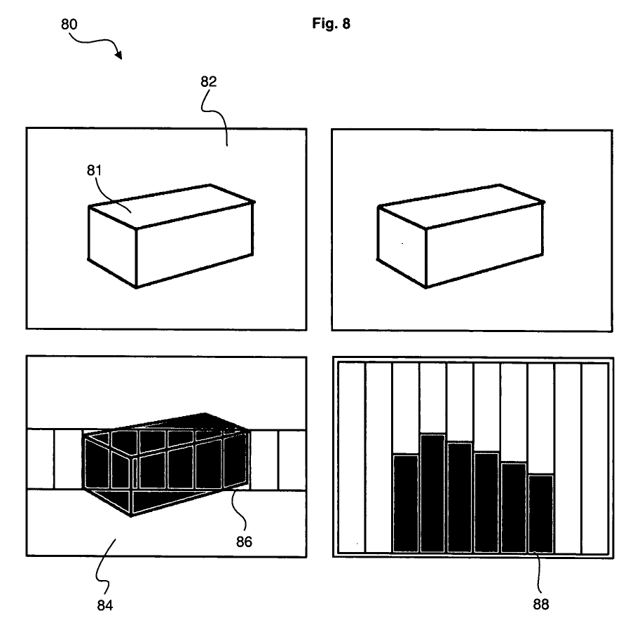

FIG. 8 shows a further simplified example of an example screen dump 80 of the ENVS control panel at one instant while a user surveys the environment to determine the user's location. The approximated height, width and range of the object 81 in image 82 can be plainly seen in the depth map 84 overlayed with depth map sample regions 86. The corresponding intensity of the TENS pulses felt by each region of skin can be seen on the bar graph 88. The inability of stereo cameras to resolve the depth of featureless surfaces is not considered a problem within a cluttered environment because of sufficient edges and features of objects in the environment. However, the inability of stereo cameras to resolve the range of featureless surfaces can pose a problem for the user in environments that contain flat featureless walls and/or large objects. To overcome this problem infrared range sensors or beam projectors can be incorporated to enable the range of such surfaces to be resolved.

It is also possible that a 2D matrix could provide information about the range of objects level with the user's head and simultaneously information about the range of objects near the user's feet.

It is also possible to utilise colour information received from a camera. The predominate colour of a region 86 could be obtained and used to modulate the frequency of the signal sent to the electrodes or actuators. Thus, a user could also be provided with information about the colour of objects in the environment.

Furthermore, an alternative location for the electrodes or actuators to be placed might be on the fingers of the user. In this case the intensity and frequency of the stimulation felt at each finger might indicate the range and colour of the objects pointed at by each finger when the fingers are extended and pointed in the direction of the cameras. However, this option might interfere with the user's sense of touch, particularly if the electrodes are mounted internally within gloves.

Thus, there has been provided a device for providing perception of the spatial environment about a user.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although a preferred embodiment has been described in detail, it should be understood that various changes, substitutions, and alterations can be made by one of ordinary skill in the art without departing from the scope of the present invention.

1. A device for providing perception of the spatial environment about a user, the device comprising:
(a) at least one range sensing device;
(b) a processing device to receive data from the at least one range sensing device and to generate a depth map from at least some of the data;
(c) a signal converter to generate an electrical signal corresponding to an area of the depth map; and,
(d) a tactile interface to receive the electrical signal, the tactile interface operatively attached to the user.

2. The device as claimed in claim 1, wherein the at least one range sensing device comprises a camera and a range sensor.

3. The device as claimed in claim 2, wherein the range sensor is a scanning range sensor.

4. The device as claimed in claim 1, wherein the at least one range sensing device is a stereo camera set comprising a first camera and a second camera.

5. The device as claimed in claim 1, wherein the at least one range sensing device comprises a plurality of range sensors.

6. The device as claimed in claim 1, wherein the signal converter generates a plurality of electrical signals each corresponding to one of a plurality of areas of the depth map.

7. The device as claimed in claim 1, wherein electrical characteristics of the electrical signal can be altered using the signal converter.

8. The device as claimed in claim 1, wherein the device is a sensory aid for a blind user.

9. The device as claimed in claim 1, wherein the tactile interface comprises one or more electrodes.

10. The device as claimed in claim 1, wherein the tactile interface comprises one or more transducers.

11. The device as claimed in claim 10, wherein the one or more transducers are vibro-tactile actuators.

12. The device as claimed in claim 1, wherein the tactile interface comprises one or more electrodes and one or more transducers.

13. The device as claimed in claim 1, wherein the tactile interface is adapted to be at least partially attached to the abdomen of the user.

14. The device as claimed in claim 1, wherein the tactile interface is arranged as a two-dimensional array on a region of skin of the user.

15. The device as claimed in claim 1, wherein the tactile interface is in the form of two gloves and comprises ten electrodes or transducers each corresponding to a digit of the user's hands.

16. The device as claimed in claim 1, wherein the at least one range sensing device is adapted to be mounted on the user's head.

17. The device as claimed in claim 2, wherein:
(b1) the processing device also generates a colour map corresponding to the depth map; and,
(c1) the signal converter also modulates the electrical signal corresponding to a predominant colour of an area of the colour map.

18. The device as claimed in claim 17, wherein operation of the tactile interface varies according to the modulated electrical signal.

19. The device as claimed in claim 17, wherein the tactile interface comprises a two-dimensional array of vibro-tactile actuators and different frequencies of operation of the vibro-tactile actuators correspond to different colours.

20. The device as claimed in claim 1, wherein the range sensing device includes at least one infra-red sensor to obtain the temperature of an object.

21. The device as claimed in claim 1, wherein the at least one range sensing device includes one or more lasers.

22. The device as claimed in claim 1, wherein the device includes a GPS and the processing device can perform a range calculation on a received GPS signal.

23. The device as claimed in claim 1, wherein the at least one range sensing device includes one or more cameras to obtain an image and the processing device can perform image recognition on the image.

24. The device as claimed in claim 23, wherein the image recognition is optical character recognition of text within the image.

25. The device as claimed in claim 24, wherein recognised text is imparted to the user via the tactile interface or an audio signal.

26. A method of providing perception to a user of the spatial environment about the user, the method including the steps of:
(a) using at least one range sensing device provided on or about the user to receive electromagnetic radiation from the spatial environment about the user;
(b) processing in a processing device data received from the at least one range sensing device and generating a depth map from at least some of the data;
(c) generating in a signal converter an electrical signal corresponding to an area of the depth map; and,
(d) receiving in a tactile interface the electrical signal, the tactile interface operatively attached to the user.

27. A sensory aid comprising:
(a) range and vision sensor devices for obtaining an array of colour and range readings from the environment;
(b) processing hardware connected to the range and vision sensor devices; and,
(c) a configuration of electro-tactile electrodes or vibro-tactile actuators mounted on the skin of a user;
wherein, the array of colour and range readings are mapped to the configuration of electro-tactile electrodes or vibro-tactile actuators, such that the direction and distance of objects in the environment can be sensed by the location and the intensity of the stimulation from the electro-tactile electrodes or vibro-tactile actuators, also such that the colour of objects in the environment can be sensed by the frequency of the stimulation.
